(19) United States
(12) Patent Application Publication
(10) Pub. No.: US 2005/0012564 A1
(43) Pub. Date: Jan. 20, 2005

(54) Co-planar constant-attenuation phase modifier

(76) Inventor: Joerg Schoebel, Salzgitter (DE)

Correspondence Address: Striker Striker & Stenby, 103 East Neck Road, Huntington, NY, 11743, US

(21) Appl. No.: 10/494,399

(22) PCT Filed: Jun. 12, 2003
(86) PCT No.: PCT/DE03/01962

(30) Foreign Application Priority Data
Aug. 24, 2002 (DE) 102 38 947.7

(51) Int. Cl. H01P 1/18

(52) U.S. Cl. 333/164; 333/161

(57) ABSTRACT

The invention relates to a phase shifter for high-frequency electric lines (36), wherein phase shifting is essentially achieved by specifically selecting the line length, the device essentially consisting of a circuit arrangement (30) equipped with coplanar lines. The adjustment possibilities of the various-length coplanar lines (32, 34) with regard to ohmic damping and impedance are preselected in such a way that ohmic damping and impedance are essentially the same on the selectively controllable, various-length conductive paths (32, 34) of the circuit arrangement (30). Adjustment possibilities include the width w of the particular central conductor (24) and the width b of the outer conductor (22), in addition to the spacing g between the central conductor (24) and the outer conductor (22). In conforming the various-length lines (32, 34), the situation that is specific for coplanar lines is utilized, namely that the impedance depends on w and g, but the ohmic resistance depends essentially only on w, that is, these two physical variables are capable of being adjusted quasi independently of each other. Since the ohmic damping and impedance are the same for the various-length conductive paths (32; 34), a change-over of the phase state is achieved while the insertion loss remains nearly constant. Phase shifters of this nature are suitable for beam sweeping in phased arrays in motor vehicle sensor technology. The radiation characteristics remain the same when the phase is shifted.

### BACKGROUND INFORMATION

The present invention is based on devices for phase shifting for high-frequency electric lines, wherein phase shifting is essentially achieved by specifically selecting the line length.

Phase shifters are devices with which the phase of a signal and/or an alternating current for the subsequent locations of a line or other electrical devices are shifted in comparison to the state without phase shifters and/or in comparison to parallel lines. Phase shifters of this nature are usually switchable, so that at least two phases that are shifted relative to each other are alternately selectable. “High frequency”, in the sense of the present application, refers to frequencies that are suitable for radar or microwave antennae or communications technology, whereby frequencies for wavelengths in the millimeter range are covered in particular by the invention.

Switchable phase shifters are used primarily in phased arrays, which are currently of great interest in the field of automotive technology. Phased arrays as microwave antenna with electronically steerable or switchable radiation lobes are preferably considered specifically for the further development of motor vehicle radar ranging sensors. Possible fields of applications in the automotive industry include long range radar (LLR) for adaptive cruise control (ACC), and short range radar (SRR), e.g., for parking aids, blind zone monitoring and pre-crash airbag release. Furthermore, there is a large number of civil and military applications in the field of radar and communications [1].

In the operation of a phased array 1 of this nature, which is depicted schematically in FIG. 1, the transmit signal from a signal source 3 is first divided by power splitter 5 in accordance with a specified amplitude distribution into M columns and/or N lines, out of which phased array 1 is composed. Beam sweeping takes place in the plane (or in both planes) perpendicular to the columns (or lines) of antenna 1 in that the phases of the signals that are emitted from individual antenna elements 9 are shifted relative to each other using switchable phase shifters 7.

A large number of concepts for phased arrays with a steerable radiation lobe and for phase shifters is known in the related art. Refer, for example, to [2], [3], [4] in the list of literature references provided at the end of the present description.

One certain type of phase shifter is the detour phase shifter. Two or more line sections having different lengths are switched alternately between the input and output of said detour phase shifter, so that the signal travels from the input to the output via one of the lines. The desired phase shift is obtained via the line lengths. For more than two phase states, detour phase shifters are usually cascaded. Variations with 1-on-4 change-over switches, for example, that switch between four line sections, are known as well.

There are different possibilities for realizing the change-over switches. For example, the lines can be short-circuited at a spacing of one-fourth of a wavelength from the branching. Micro-electromagnetic switches (MEM switches), in particular, are used in the high-frequency range, because they have very good high-frequency characteristics. Other switches that are suitable for high-frequency signals, such as pin diodes, FETs or HEMTs (high electron mobility transistor), are also used in phase shifters, however. Refer to [4 Vol. 2].

Reflection phase shifters are another type that is known in the related art. With reflection phase shifters, the path of the signal to a directional coupler or a circulator is changed by switching the length of the signal paths up to one or more transition points, thereby varying the phase [4 Vol. 2].

“Loaded line” or “stub-loaded line” phase shifters are another type that is known in the related art [4], [12]. With phase shifters of this nature, the phase of the signal is varied by influencing the propagation coefficient of the signal in the line by overriding reactances that are formed, e.g., using different line lengths (“stubs”).

In reflective “loaded line” and “stub-loaded line” phase shifters, the phase shift can also be achieved by switching over between different reactances, instead of between different line lengths. These reactances can be formed, e.g., by changing the capacitance of a pin diode or by switching over a HEMT (high electron mobility transistor) from the off-state to the on-state. Hybrid forms are possible as well, e.g., switching a line length while simultaneously utilizing the changing reactance of the switching element. The switching elements should have a (capacitive or inductive) reactance, of which the ohmic portion should be as low as possible, because the ohmic portion results in losses in the phase shifter.

A general problem with all phase shifters that are based on the concept that the signal travels along path having a different length depending on the desired phase state, as is the case with reflection phase shifters and detour phase shifters, for example, is that damping increases with signal path length.

The amplitude distribution of the signals on the antenna elements therefore changes, depending on the phase states of the signals, which results in the radiation characteristics of the antenna changing. In general, the suppression of the minor lobes, in particular, worsens.

Since the ohmic losses of pin diodes or HEMTs, for example, differ in the off-state state and the on-state in phase shifters with switched reactances, this also results in a variation of the output amplitude of the phase shifter with the phase state, even when the line length does not change when the phase state is switched.

In “loaded line” phase shifters, the propagation coefficient and, therefore, in general, the line impedance, changes. The line impedance, which changes with the phase state, results in a mismatch that varies with the phase state and, therefore, in an insertion loss that varies with the phase state.

The dependence of the insertion loss on the phase state has not yet been reduced to a satisfactory extent, despite considerable efforts. “Insertion loss” is understood to mean the damping of the signal that is due to the phase shifters that are inserted in the conductive path. It essentially depends on the mismatch of the inputs and outputs of the phase shifter, the line losses, and the ohmic losses of the switching elements.

Although phase shifters with MEM switches using microstrip technology, configured as reflection phase shifters [8] or detour phase shifters [9], exhibt one of the lowest insertion losses known from the applicable literature, the insertion loss still exhibits a variation of approximately 1 dB, depending on the phase state. This value is still too high. As a result, the application of phase shifters of this nature for phased arrays in sensor technology, in particular, is problematic.

In military radar systems, vector modulators that can modulate the signal in phase and amplitude are used in beam shaping. This would allow a variation of the insertion loss of the phase modulator to be corrected by the amplitude modulator. In “moderate” cost applications such as motor vehicle ranging sensors, concepts of this nature are not yet practicable, however, because they are very cost-intensive.

Further efforts to rectify the damping problem, so far inadequate, are being carried out in the field of coplanar technology. Coplanar lines have become increasingly well-established in high-frequency switches in the millimeter-wave range. The configuration of said lines 10 is illustrated in FIGS. 2 and 3. Located on a substrate 20 having thickness d, which said substrate can be composed of numerous layers, are two metallic outer conductors 22 with a metallic central conductor 24 located between them. Central conductor 24, which carries the signal, has width w and height tw. Two outer conductors 22 have widths ba and bb, and heights ta and tb. Widths ga and gb of gaps 26 between central conductor 24 and outer conductors 22 are usually the same, but are not necessarily so.

The description of a phase shifter that is composed of a “stub-loaded line” phase shifter and a reflection phase shifter with coplanar lines and HEMT switches is provided in [10]. The insertion loss varies by approximately 5 dB with the phase state, however, which is far outside the tolerance range for the application in phased arrays, in particular.

### ADVANTAGES OF THE INVENTION

With the device as recited in Claim 1, a change-over of the phase state is achieved for high-frequency electric lines while the insertion loss remains nearly the same. According to the invention, when the ohmic damping and impedance in the various-length lines are conformed, the situation that is specific for coplanar lines is utilized, namely that the impedance depends on width w of the central conductor and gap width g, but the ohmic damping depends essentially only on w, that is, these two physical variables are capable of being adjusted quasi independently of each other. Further technical background about this is provided in [5], [6], [7].

Since the ohmic damping and impedance are nearly the same for the various-length conductive paths, the insertion loss is nearly the same for both paths. Phase shifters of this nature are suitable for beam sweeping in phased arrays in motor vehicle sensor technology. The radiation characteristics remain the same when the phase shifts.

As a result, according to the invention, phase changes for beam sweeping with amplitude distribution that remains the same are made possible for phased arrays in a cost-effective manner. The radiation characteristics therefore remain independent of the phase position, and the suppression of the minor lobes is therefore ensured to remain the same.

Advantageous embodiments, further developments and improvements of the particular object of the invention are indicated in the subclaims.

According to an advantageous embodiment of the present invention, by adjusting the width w of the central conductors and the spacing g of the central conductors from the particular outer conductors, it is possible to obtain essentially the same impedance and the same ohmic damping for various-length coplanar conductive paths. As a result, the insertion loss is nearly independent of the phase state. Even more advantageous is the possibility of also incorporating the width of the outer conductors as a variable parameter in the conforming of impedances and ohmic dampings. This expands the range of feasible phase shifts for the case in which the remaining basic conditions, such as the size of the phase shifter, are fixed.

An advantageous further development according to the invention is the use of tapers for transitions to other line geometries. A taper is a coplanar line section with changed line geometry, e.g., with regard for w, g and b, but with an unchanged line impedance, whereby the transitions take place via gradual, quasi flowing changes in the line dimensions. The flowing transitions allow reflectances and emissions to be avoided. The use of one or more tapers with a tapered central conductor as the damping element is also an advantage.

Furthermore, conductive bridge connections between the outer conductors of a coplanar line that extend over or under the central conductor are advantageous; this applies for the areas of line branchings, in particular. The interfering second mode is suppressed as a result, as described in [11].

In addition, the ohmic damping can be varied by using inductive line sections with central conductors that are tapered accordingly. Said line sections serve primarily for compensation, with regard for line impedance, of the additional capacitance that is brought about by the bridge connections. This is achieved by increasing the inductivity. The tapering of the central conductors that is useful for this purpose has the additional effect of increasing the ohmic damping of the shorter coplanar lines, so that it can therefore be adapted to that of the longer lines. For purposes of conforming, the capacitance of the bridge connections and, therefore, the length of the compensating inductive line sections can be increased accordingly. A larger number of standardized bridge connections or a variation in the width of such connections are other advantageous possibilities.

There is a large number of further advantageous embodiments according to the invention for equalizing the ohmic damping. For example, to name but a few, additional damping material can be provided on the coplanar lines of the shorter conductive paths, the cross section of the central conductor can be reduced, or material with lower conductivity can be used.

A further advantageous embodiment according to the invention is the use of MEM switches as switching elements, because they have very good high-frequency characteristics, in particular low ohmic damping.

### DRAWING

Preferred exemplary embodiments of the present invention are explained with reference to the drawing.

FIG. 1 shows a schematic configuration of a phased array with two radiation lobes that are capable of being steered in two directions, according to the related art;

FIG. 2 is a sketch of the configuration of a coplanar line according to the related art, shown in a top view;

FIG. 3 is a sketch of the configuration of a coplanar line according to the related art, shown as a cross section from the front;

FIG. 4 is a basic structure of a detour phase shifter, according to the invention, in coplanar technology;

FIG. 4a is a variation of the basic structure of a detour phase shifter, according to the invention, in coplanar technology;

FIG. 4b is a further variation of the basic structure of a detour phase shifter, according to the invention, in coplanar technology;

FIG. 5 is a sketch of a taper for transitioning to a different coplanar line geometry;

FIG. 5a is a sketch of a variant of a taper for increasing the ohmic damping;

FIG. 6 is a sketch of a coplanar line with bridge connection, shown in cross section from the front;

FIG. 7 is a sketch of a coplanar line section with bridge connection and the inductive line section that for compensates for the capacitance of said bridge connection, with regard for impedance;

FIG. 8 is a view of a line branching with connection bridges in an embodiment, according to the invention, of a detour phase shifter in coplanar technology.

### DETAILED DESCRIPTION OF THE EMBODIMENTS

In the figures, the same reference numerals refer to the same or functionally-equivalent components.

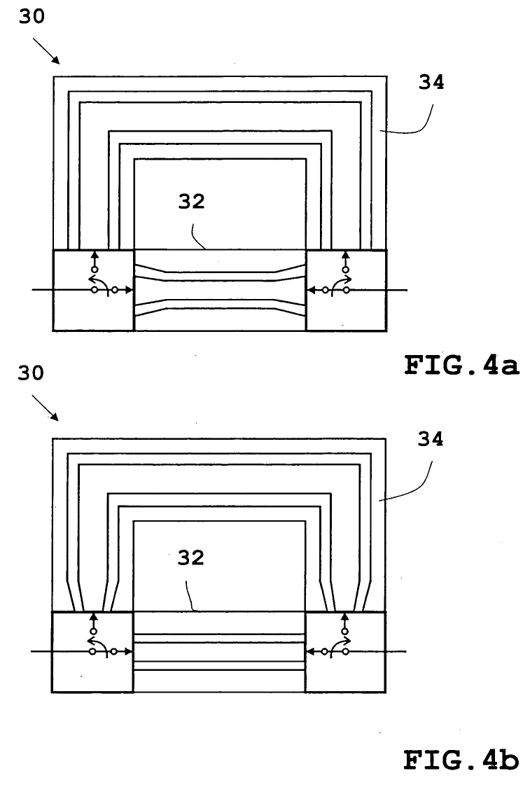

FIG. 4 is a sketch of the basic structure of a detour phase shifter 30, according to the invention, in coplanar technology. FIGS. 4a and 4b are variations of embodiments, according to the invention, of a detour phase shifter 30 of this nature.

Detour phase shifter 30 contains a coplanar line 32 with a short conductive path, and a coplanar line 34 with a long conductive path. Width w of central conductor 24 and spacing g between central conductor 24 and outer conductors 22 are correspondingly smaller in the shorter coplanar line section 32 as compared to the longer coplanar line section 34, in order to obtain the same impedance and ohmic damping. For example, as shown in FIG. 4a, the shorter coplanar conductive path 32 or, as shown in FIG. 4b, the longer coplanar conductive path 34, can deviate from the line geometry that prevails in the remaining coplanar lines, or both of them deviate from a third line geometry that is used in the rest of the circuit. To prevent reflectances and emissions, the transitions between the line geometries are designed to be gradual, quasi flowing, over a sufficient length.

Switches 38 that are located at the input and output of phase shifter 30 allow the selection of which of the two conductive paths 32, 34 and, therefore, which phase shift, to utilize. Switches 38 are MEM switches. Other switches can also be provided, such as pin diodes, FETs or HEMT switches.

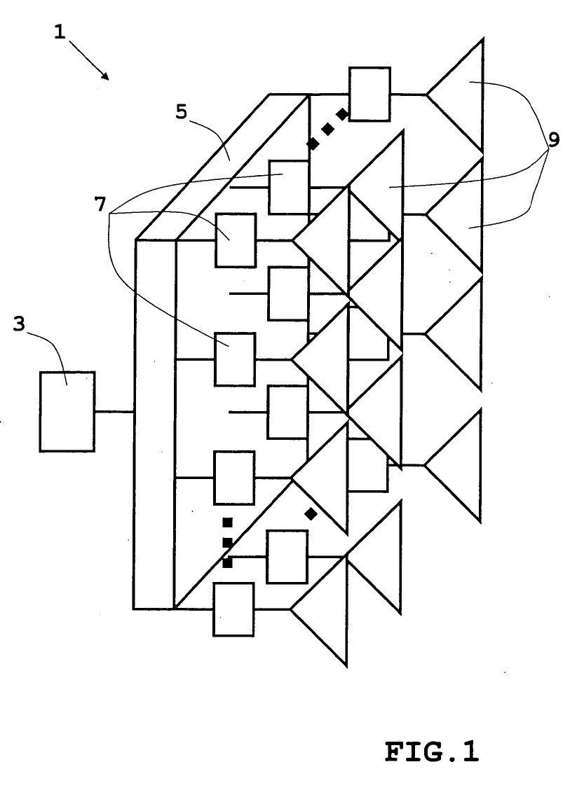

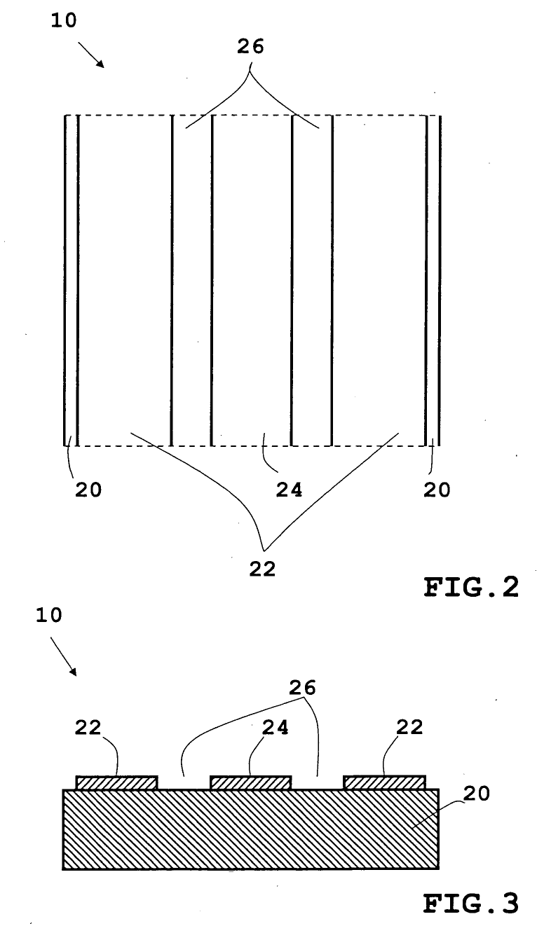

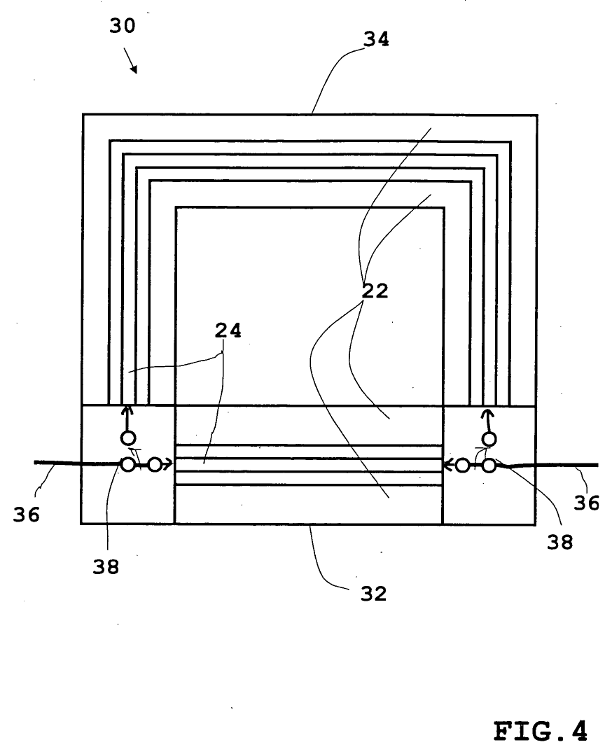

For use in phased arrays with beam sweeping, for example, detour phase shifter 30 is inserted in a high-frequency electrical line 36, e.g., in front of an antenna element 9 of a phased array, as shown in FIG. 1. It is connected at its input and output, in an impedance-adjusted manner, with the ends of high-frequency line 36.

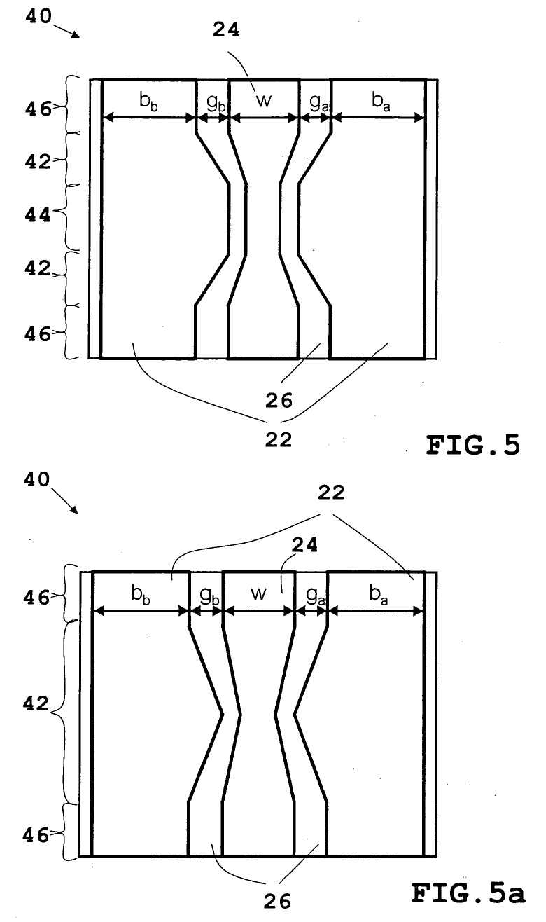

FIG. 5 is a schematic sketch of a taper 40 used in a further development of the invention. The line dimensions of central conductor 44, such as width w of central conductor 24, and widths ba and bb of outer conductors 22, and widths ga and gb of gaps 26 between lines 22, 24 are changed with regard for coplanar line sections 46 that are adjacent to taper 40. The ratio of the line dimensions is always selected in such a manner that the line impedance remains the same. Transitions 42 to the line geometries of adjacent coplanar line sections 46 take place via gradual, quasi flowing changes in the line dimensions. As shown in FIGS. 5 and 5a, width w and spacing g (and ga and gb), for example, become smaller toward the center of taper 40, whereby the variation sketched in FIG. 5a is unusual in that it does not have a middle section. Due to the narrowing of the central conductor, it serves as damping element.

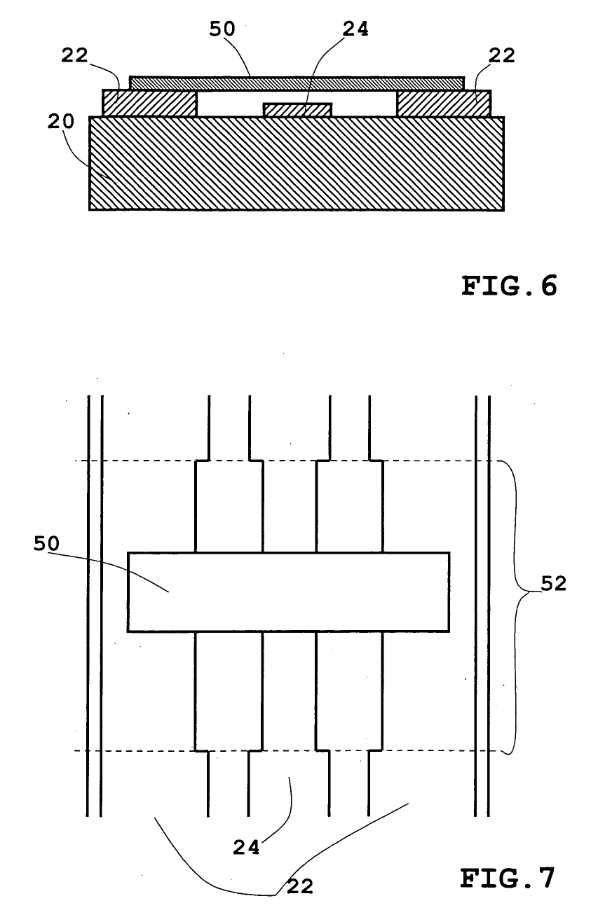

Bridge connections 50 and their application in embodiments according to the invention are shown in FIGS. 6 through 8.

FIG. 6 is a schematic illustration of a coplanar line with a bridge connection 50 shown in cross section from the front. Bridge connection 50 is a conductive wafer, composed, e.g., of aluminum, which is attached to outer conductors 22 and joins them in a conductive manner. In this case, outer conductors 22 are higher than central conductor 24, so that bridge connection 50 has a corresponding spacing from central conductor 24. Various other possibilities for bridge connections 50 are also feasible, however, to cross central conductor 24 without a conductive connection. For example, a connection of outer conductors 22 could run through a hidden bridge 50 under central conductor 24, or central conductor 24 could extend over or tunnel under bridge connection 50. In integrated phase shifters (e.g., in MMICs) in GaAs—, SiGe or silicon/MEMS technology, the bridge is typically formed out of a metal layer that otherwise also covers all lines. The central conductor in the area of the bridge is composed of a metal layer having a lower height.

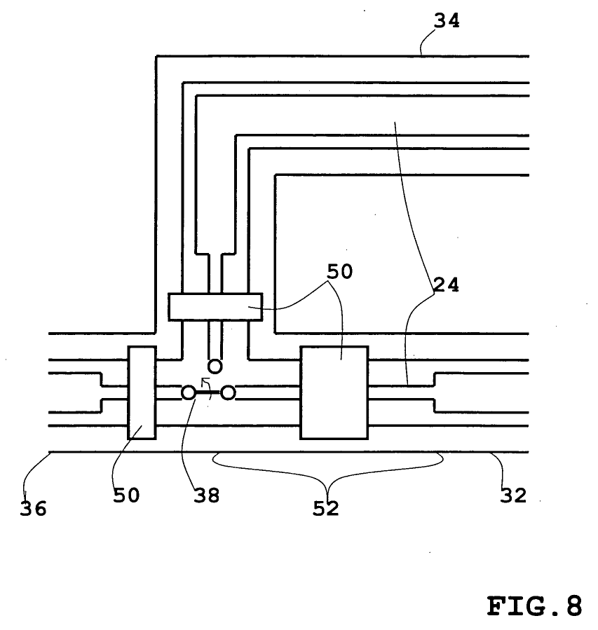

FIG. 7 shows a coplanar line section with bridge connection 50 and inductive line section 52 that compensates for its capacitance with regard for impedance. Bridge connection 50 having width A is located in the center of inductive line section 52. To increase inductivity, line section 52 has a tapered (narrower) central conductor 24 and outer conductors 22 that are removed therefrom via a larger spacing g and are also narrower, whereby their width can also be unchanged. Length L of inductive line section 52 is tailored exactly in such a manner that a compensation of capacitance takes place via bridge connection 50 with regard for impedance. The ohmic damping is increased by the narrower central conductor 24. The bridge does not necessarily have to be located exactly in the center of the compensating line section.

The ohmic damping of shorter coplanar line 32, as shown in FIG. 8, can therefore be adjusted to the ohmic damping of longer coplanar line 34 in accordance with the invention by using bridge connections 50 that are wider and, as a result, equipped with greater capacitance and, therefore, correspondingly longer inductive line sections 52. Bridge connections 50 are located on each of the line ends of a coplanar line branching with MEM switch 38 at the input and output of a detour phase shifter 30 according to the invention. As a result, the second mode that interferes with the signal is optimally suppressed.

Although the present invention was described hereinabove with reference to a preferred exemplary embodiment, it is not limited thereto; instead, it is capable of being modified in a diverse manner.

For example, phase shifters are also capable of being used that are composed of a combination of detour phase shifters, in accordance with the invention, with another, e.g., “stub-loaded line”, phase shifter.

The phase-shift range can therefore be increased as a result, or a more detained phase adaptation can take place, whereby the insertion loss can be kept nearly constant, independently of the phase state, via the tailored sizing of the particular, various-length coplanar lines of the detour phase shifter.

In addition to its application for sensors in the automotive industry, the phase shifter, according to the invention, can also be used, among other things, in communication technology for future communication, mobile radio, and satellite radio applications with space-division multiple access (SDMA: user connections over spacially limited, user-specific radiation lobes of the base station or satellite and/or the user unit), and civil or military radar systems.

Finally, features of the subclaims can be essentially combined freely with each other, and not in the order in which they appear in the claims, as long as they are independent of each other.

Literature

[1] N. Fourikis, Advanced Array Systems, Applications and RF Technologies, Academic Press, San Diego, etc., 2001
[2] R. i. Maillous, Phased Array Antenna Handbook, Artech House, Boston, London 1994.
[3] D. M. Pozar, D. H. Schaubert, Microstrip Antennas, IEEE Press, New York 1995.
[4] S. K. Koul, B. Bhat, Microwave and Millimeter Wave Phase Shifters, Vol. 1 and 2, Artech House, Boston, London 1991.
[5] R. K. Hoffmann, Integrierted Mikrowellenschaltungen, Springer-Verlag, Berlin, etc., 1983.
[6] G. Ghione, C. U. Naldi, Coplanar Waveguides for MMIC Applications: Effect of Upper Shielding, Conductor Backing, Finite-Extent Ground Planes, and Line-to-Line Coupling, IEEE Trans. Microwave Theory Tech. MTT-35, 260-267, 1987.
[7] G. Ghione, A CAD-Oriented Analytical Model for the Losses of General Asymmetric Coplanar Lines in Hybrid and Monolythic MICS, IEEE Trans. Microwave Theory Tech. 41, 1499-1510, 1993.
[8] A. Malczweski, S. Eschelman, B. Pillans, J. Ehmke, C. L. Goldsmith, X-Band RF MEMS Phase Shifters for Phased Array Applications, IEEE Microwave Guided Wave Lett. 9, 517-519, 1999.
[9] B. Pillans, S. Eshelman, A. Malczewski, J. Ehmke, C. L. Goldsmith, KA-Band RF MEMS Phase Shifters for Phased Array Applications, IEEE MTT-S International Microwave Symposium Digest, IEEE, New York, 2000.
[10] K. Zuefle, F. Steinhagen, W. H. Haydl, A. Hülsmann, Coplanar 4-bit HEMT phase shifters for 94 GHz phased array radar systems, IEEE MTT-S International Microwave Symposium Digest, IEEE, New York, 1999.
[11] E. Rius, J. P. Coupez, S. Toutain, C. Person, P. Legaud, Theoretical and Experimental Study of Various Types of Compensated Dielectric Bridges for Millimeter-Wave Coplanar Applications, IEEE Trans. Microwave Theory Tech. 48,152-156, 2000.
[12] R. E. Collin, Foundations for Microwave Engineering, 2^{nd} ed. McGraw-Hill, New York, etc., 1992.

1. A device for phase shifting for high-frequency electric lines (36), whereby phase shifting is essentially achieved by specifically selecting the line length,
wherein a circuit arrangement (30) equipped with coplanar lines (10) is provided, the adjustment possibilities of which said various-length coplanar lines with regard to ohmic damping and impedance are preselected in such a way that ohmic damping and impedance are essentially the same on the selectively controllable, various-length conductive paths (32, 34) of the circuit arrangement (30).

2. The device as recited in claim 1,
wherein the adjustments with regard for ohmic damping and impedance for the various-length coplanar conductive paths (32; 34) are provided at the least via a specifically preselected width w of the central conductor (24) and a specifically preselected spacing g of the central conductor (24) from the outer conductors (22).

3. The device as recited in claim 2,
wherein the width b of the outer conductors (22) of the various-length, coplanar conductive paths (32; 34) is specifically preselected.

4. The device as recited in claim 1, wherein at least one coplanar line (10) of the various-length conductive paths (32, 34) contains at least one taper (40).

5. The device as recited in claim 1,
wherein at least one conductive bridge connection (40) is located between each of the outer conductors (22) of each coplanar conductive path (32, 34).

6. The device as recited in claim 5,
wherein, for line branchings, the bridge connections (50) are located at least on each of the branching-in and branching-off areas of the coplanar lines (10).

7. The device as recited in claim 5,
wherein the particular coplanar conductive paths (32, 34) contain at least one inductive line section (52) that is designed to compensate for the additional capacitance, with regard for line impedance, that is brought about by the bridge connections (50).

8. The device as recited in claim 7,
wherein the various-length, coplanar conductive paths (32, 34) for ohmic damping that is essentially the same overall include inductive line sections (52) that differ in terms of the width and length of a tapered (narrower) central conductor (24), whereby the particular bridge connections (50) are configured in terms of shape and/or type to bring about the particular different, compensating capacitance with regard for line impedance.

9. The device as recited in claim 8,
wherein the particular compensating capacitance is brought about using various-width bridge connections (50).

10. The device as recited in claim 7,
wherein the various-length, coplanar conductive paths (32; 34), for damping that is the same overall, contain a different number of identical inductive line sections (52) with a tapered central conductor (24), whereby the bridge connections (50) have an identical configuration to bring about the particular compensating capacitance.

11. The device as recited in claim 1,
wherein, for ohmic damping that is essentially the same overall, damping material with correspondingly high additional ohmic damping is applied on the coplanar lines of the conductive paths (32) that are shorter than the longest conductive path (34).

12. The device as recited in claim 1,
wherein the sizes of the cross sections of the central conductors (24), in particular with regard for the height of the central conductors (24), with consideration for additional ohmic dampings that are induced by bends in the line in particular, are designed for the particular, various-length coplanar conductive paths (32, 34) in such a manner that the ohmic damping on the conductive paths is essentially the same.

13. The device as recited in claim 1,
wherein, for the ohmic damping of the various-length conductive paths (32, 34) that is essentially the same overall, the central conductors (24) of the shorter conductive paths (32) are composed of a material having correspondingly lower conductivity.

14. The device as recited in claim 1,
wherein, for the damping that is essentially the same overall, the conductivity of the substrate (20) of the particular coplanar conductive paths (32, 34) is designed differently accordingly.

15. The device as recited in claim 1,
wherein a layer, composed of silicon oxide in particular, is inserted—along a length that is adjusted accordingly—in the gaps (26) between the central conductor (24) and the outer conductors (22) for the damping—that is essentially the same overall—of the coplanar lines, each having various-length conductive paths (32, 34).

16. The device as recited in claim 1that contains microelectromechanical switches (MEM switches) (38) for switching over.

17. Phased arrays (1) containing a device as recited in claim 1.
